(19) United States
(12) Patent Application Publication
(10) Pub. No.: US 2017/0125960 A1
(43) Pub. Date: May 4, 2017

(54) ELECTRICAL GROUNDING OF BEARING SEAL

(71) Applicants: Andrew Colverson, Rotherham (GB); Oliver Pogmore, Rotherham (US)

(72) Inventors: Andrew Colverson, Rotherham (GB); Oliver Pogmore, Rotherham (US)

(73) Assignee: AES Engineering Ltd., Rotherham (GB)

(21) Appl. No.: 15/341,926

(22) Filed: Nov. 2, 2016

(30) Foreign Application Priority Data
Nov. 2, 2015 (GB) GB1519362.6

(51) Int. Cl. H01R 39/64; H02K 5/10; H02K 11/40; F16J 15/453; H01R 39/02

(52) U.S. Cl. CPC H01R 39/64; F16J 15/453; H01R 39/025; H02K 11/40; H02K 5/10

(57) ABSTRACT

A bearing seal includes a rotor and a stator and at least one electrically conductive elastomeric toroidal member. When the bearing seal is installed in equipment and is providing sealing between the rotor and the stator, an electrical grounding path is provided therebetween, the electrical grounding path extending through the electrically conductive elastomeric toriodal member.

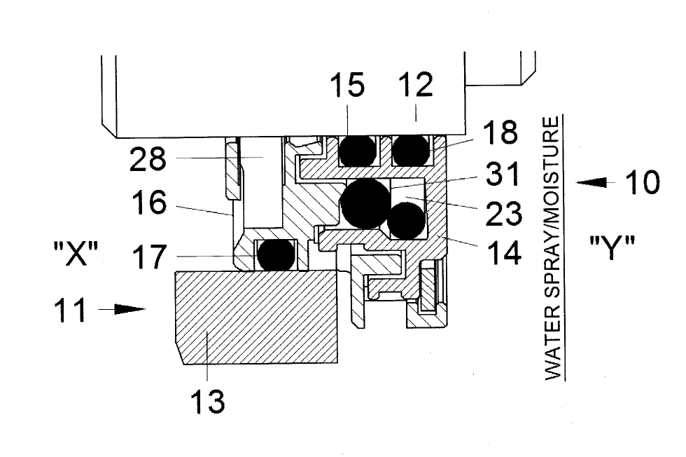

### BACKGROUND OF THE INVENTION

Technical Field of the Invention

The present invention relates to bearing protectors.

More particularly, the present invention relates to non-contacting labyrinth seals and their use in rotating equipment, especially equipment which has the potential of creating electric shaft voltages.

Description of the Prior Art

An example of a piece of rotating equipment, which has the potential of creating electric shaft voltages caused by variable frequency drives (VFD), is an electric motor with bearing assemblies supporting the rotating shaft.

In such equipment, each bearing assembly typically consists of at least one bearing housed in a bearing chamber. The bearing is lubricated and is sealed between the rotor-to-stator interface to prevent the ingress or egress of fluid or solid to the bearing cavity, since such unwanted material results in the deterioration of equipment life.

Bearing seals are often also referred to as bearing protectors or bearing isolators. However, such seals have uses other than the protection of a bearing in rotating equipment. While reference will be made below to bearing protectors, it should be understood that this term is used, as far as the invention is concerned, in connection with such other uses of the seals.

During electric motor operation, the motor bearings may deteriorate as a result of transient shaft voltages generated by the equipment, these voltages being transmitted from the shaft through the equipment bearings into the grounded bearing/motor housing. Such voltages lead to equipment bearing pitting and fluting damage.

The purpose of a bearing protector is to prevent the ingress of fluid, solids and/or debris from entering a bearing chamber. Equally, bearing protectors are employed to prevent the egress of fluid or solids from a bearing chamber. Essentially, their purpose is to prevent the premature failure of the bearing.

Non-contacting bearing protectors can be of a repeller or labyrinth configuration. Reference is made to the inventors' labyrinth seal bearing protection United Kingdom patent application, No. GB0415548.7, which describes a substantially, non-contacting bearing protector with a static shut-off device.

In a non-contacting bearing protector, the rotating component typically has a complex outer profile which is located adjacent and in close radial and longitudinal proximity to a complex inner profile of the stationary component. Together these complex profiles provide a tortuous path preventing, or at least hindering, the passage of the unwanted materials or fluids.

Non-contacting bearing protectors offer specific advantages over contacting designs, specifically in low/marginal bearing lubrication applications involving high shaft speeds, as commonly found in electric motors.

Conventional electrical voltage dissipating labyrinth seal technology involves a contacting element in the form of a series of wire brushes or spring loaded carbon bushes acting on the primary rotating shaft. Such a conventional contacting element is located adjacent to the lubrication fluid and, when contacted by this fluid, the fluid acts as an insulator and prevents the effective dissipation of the electric voltage from the rotating to stationary elements.

Because the conventional counter rotational contacting and dissipating surfaces are positioned directly on the equipment shaft, they cause wear to the equipment shaft, causing extensive damage and debris which is costly to replace and/or repair. As the abraded/worn particles are also adjacent to the bearing lubrication media, they can work their way into the counter rotational surfaces of the bearing leading to damage and bearing failure.

Furthermore, various arrangements known to the prior art compromise fundamental elements of bearing seal technology in order to incorporate voltage dissipating contacting elements into the bearing seal. Often the inboard velocity reducing cavity is excluded, which means the lubricant is more likely to leak through the bearing seal. The contacting elements may be positioned to provide a leak path between the atmospheric side and the lubricated side of the lubricated inner surfaces of the bearing chamber, thereby negating any benefit that the user expects when using a bearing seal.

Conventional arrangements include a first counter-rotational contacting element, in the form of a bush, which engages a second rotating part of the equipment, namely, a shaft, via a third member such as a spring. This arrangement compromises the equipment efficiency in that the contact biasing force is constant for any given operational speed of the equipment. As frictional heat generated is proportional to the material coefficient of friction of the counter rotational surfaces multiplied by the contacting force, it is clear that a constant force creates considerable heat even in applications which do not require such a contact force.

There is a difference in both probability and magnitude of a stray voltage occurring with an item of rotating equipment rotating at 0.1 m/s compared to that expected when the equipment rotates at 20 m/s or 30 m/s. Furthermore, all conventional voltage dissipating means rely on sliding friction between counter rotational surfaces. Sliding friction consumes considerable power for any given application and thus generates considerable heat. Rolling friction, on the other hand, provides less power and less heat generation; the fundamental reason why 95% of the world's bearings roll rather than slide.

### SUMMARY OF THE INVENTION

According to the present invention overcomes the disadvantages of the prior art by providing a bearing seal having a rotor and a stator and at least one electrically conducting elastomeric toroidal member, whereby, in use with the seal installed in equipment and providing sealing between equipment rotor and stator, an electrical grounding path is provided between said equipment rotor and said equipment stator, said path extending through said toroidal member.

Preferably, the seal includes a first electrically conducting elastomeric toroidal member which, in use, provides sealing between the equipment rotor and the rotor of the seal.

Preferably, a second electrically conducting elastomeric toroidal member provides, in use, sealing between the equipment stator and the stator of the seal.

Preferably, the bearing seal incorporates a static shut-off device, such as a seal or a valve. More preferably, the shut-off device includes at least one further electrically conductive elastomeric toroidal member which provides electrical conduction between the rotor and the stator of the seal.

Preferably, the grounding arrangement of a seal of the present invention is longitudinally and/or radially separated from the lubrication fluid being sealed. In this way, the lubrication medium is not able to reduce the efficiency of the electrical dissipation.

Other objects and features of the present invention will become apparent when considered in combination with the accompanying drawing FIGURE, which illustrates a certain preferred embodiment of the present invention. It should, however, be noted that the accompanying drawing FIGURE is intended to illustrate only a select preferred embodiment of the claimed invention and is not intended as a means for defining the limits and scope of the invention.

### BRIEF DESCRIPTION OF THE DRAWING FIGURE

The unnumbered drawing FIGURE is a longitudinal section of one half of a labyrinth seal bearing protector of the present invention in a rotationally static position.

### DETAILED DESCRIPTION OF THE DRAWING FIGURE AND PREFERRED EMBODIMENTS

The present invention will now be described, by way of example only, with reference to the accompanying drawing FIGURE.

Rotating equipment assembly 11 includes a rotating shaft 12 and stationary equipment housing 13. The equipment housing 13 generally contains a bearing (not shown) mounted in the radial space between the shaft 12 and housing 13.

Area “X”, adjacent to the bearing (not shown) and one axial end of the bearing protector assembly 10, generally contains bearing lubrication fluid, but could also contain solid and/or foreign debris and/or atmosphere. It will be referred to herein as “product substance” as being used to described the single or mixed medium.

Area “Y” at the other end of the bearing protector assembly 10 can also partially contain fluid, typically sprayed moisture and/or solids and/or foreign debris and/or atmosphere. It will herein be termed “atmospheric substance” being used to describe a single or mixed medium.

The bearing protector assembly 10 includes a rotor member 14, which is radially and longitudinally adjacent to stator member 16.

The stator member 16 is preferably rotationally attached to the equipment housing 13 by means of elastomeric toroidal member (e.g., O-ring) 17.

Rotor 14 is radially mounted in sealing engagement with shaft 12 by O-ring 18. A further O-ring 15 is also provided. The frictional squeeze on O-ring 15 is generally sufficient to transmit the rotational drive from the shaft 12 to rotor 14, however a separate drive mechanism could be employed to transmit the drive, if so required.

The static shut-off device 23 seals the rotor to the stator when the shaft is at rest/idle and provides a non-contact seal when the shaft is in operation.

Stator 16 incorporates a radially extending groove 28, which extends longitudinally from the innermost circumference and is substantially adjacent to the rotor or shaft 12, as shown. The groove is positioned adjacent to area “X” and the sealed media in the equipment bearing chamber 11. The groove 28 is circumferentially discontinued at the 6 o′clock position by an orifice (not show) which communicates between area “X” and the outermost radial surface of the groove 28. The outermost surface of the radial stator 16 is circumferentially discontinued at the 6 o′clock position by an orifice (not shown), which communicates between area “Y” and the innermost radial surface of the stator 16.

At least one of the two O-rings, 15, 18, is made of electrically conductive material. The O-ring 31 of the shut-off valve is also made of electrically conductive material. Furthermore, O-ring 17 is similarly made of electrically conductive material. As a result, an electrical path is provided between shaft 12 and housing 13. This path extends through one or both of O-rings, 15, 18, through the rotor 14, then through O-ring 31 of the shut-off valve through the stator 16 and, finally, through O-ring 17 before entering housing 13.

The above-mentioned electrically conducting O-rings are made of an electrically conducting HCR silicone rubber such as Elastosil R Plus 573/70 A/B made by Wacker Silicones. This material, which is a two-component silicone rubber, provides good mechanical and electrical properties. It has high conductivity, low volume resistivity, good heat resistance and good rheological properties. It has previously being proposed for use in such applications as EMI-gaskets, ignition cables (core) and band electrodes.

The general principle of rotary seals in accordance with the present invention may be used, not only in the case where the shaft is a rotary member and the housing is a stationary member, but also the reverse situation, that is to say, in which the shaft is stationary and the housing is rotary.

Furthermore, the invention may be embodied in both rotary and stationary arrangements, cartridge and component seals with metallic components, as well as non-metallic components.

While only several embodiments of the present invention have been shown and described, it will be obvious to those skilled in the art that many modifications may be made to the present invention without departing from the spirit and scope thereof.

What is claimed is:

1. A bearing seal for equipment having an equipment rotor and an equipment stator, said bearing seal comprising:
a bearing seal rotor;
a bearing seal stator;
an electrically conductive elastomeric toroidal member so that, when said bearing seal is installed in equipment, said bearing seal provides sealing between the equipment rotor and said bearing seal stator; and,
an electrical grounding path between the equipment rotor and the equipment stator, said electrical grounding path extending through said electrically conductive elastomer toroidal member.

2. The bearing seal for equipment having an equipment rotor and an equipment stator according to claim 1, wherein an additional electrically conductive elastomeric toroidal member is provided between the equipment rotor and said bearing seal rotor.

3. The bearing seal for equipment having an equipment rotor and an equipment stator according to claim 1, wherein an additional electrically conductive elastonneric toroidal member is provided between the equipment stator and said bearing seal stator.

4. The bearing seal for equipment having an equipment rotor and an equipment stator according to claim 1, further comprising a shut-off device for said bearing seal.

5. The bearing seal for equipment having an equipment rotor and an equipment stator according to claim 4, wherein said shut-off device includes an additional electrically conductive elastomeric toroidal member for providing an electrical conduction between said bearing seal rotor and said bearing seal stator.

6. The bearing seal for equipment having an equipment rotor and an equipment stator according to claim 1, wherein said electrically conductive elastomeric toroidal member is made of a silicone rubber.

7. The bearing seal for equipment having an equipment rotor and an equipment stator according to claim 6, wherein the silicone rubber is a two-component material.
